(19) United States
(12) Patent Application Publication
(10) Pub. No.: US 2024/0327036 A1
(43) Pub. Date: Oct. 3, 2024

(54) ASSEMBLY JIGS AND METHODS OF INSTALLING DOORS TO AN AIRCRAFT

(71) Applicant: Airbus Operations Limited, Bristol (GB)

(72) Inventors: Dominique CHASTEAU, Bristol (GB); Guilherme BARSALI, Bristol (GB); James BARNES, Bristol (GB); Christopher James PERKINS, Bristol (GB)

(21) Appl. No.: 18/619,536

(22) Filed: Mar. 28, 2024

(30) Foreign Application Priority Data
Mar. 31, 2023 (GB) 2304831.7

(51) Int. Cl. B64F 5/10; B64C 25/16

(52) U.S. Cl. CPC B64F 5/10; B64C 25/16

(57) ABSTRACT

An aircraft assembly jig for fitting a number of landing gear door components to an aircraft. The jig includes a lifting device for elevating the components towards the aircraft for fitting, and a number of adjustable platforms attached to the lifting device, each of which holds one of the landing gear door components. The adjustable platforms allow each of the components to be positioned independently so that when elevated together towards the aircraft by the lifting device, each component is correctly and independently aligned and positioned for installation at the aircraft.

### TECHNICAL FIELD

The disclosure herein concerns aircraft assembly jigs. More particularly, but not exclusively, this disclosure herein concerns jigs for holding and positioning components for attachment to an aircraft during assembly.

### BACKGROUND

Aircraft components such as landing gear doors and covers should be carefully fitted to aircraft so as to provide a clean and unbroken surface on the outside of the aircraft when the landing gear is retracted. By way of example, FIG. 1a shows an aircraft 101 having landing gear door components 110 including landing gear doors and door fairings in a closed configuration, with the associated landing gear assemblies (not shown) retracted in their respective landing gear bays.

FIG. 1b shows a portion of the aircraft 101 with a landing gear bay 130 and a landing gear assembly 120 together with associated components (landing gear door 140, leg fairing door 150 and hinged leg fairing door 160) in an extended configuration.

To prevent or impede the ingress of water, dirt and other foreign bodies into the landing gear bay 130, these components should all fit together as closely as possible when the landing gear assembly 120 is retracted. However, the components must not interfere with each other, since any fouling could lead to damage and potentially a landing gear extension/retraction failure.

Furthermore, for aerodynamic efficiency (minimum profile drag) the overall surface of the underside of the fuselage 105 and wings 106 should be as aerodynamically ‘clean’ as possible when the landing gear is retracted, so it is also important that the edges of these components mutually align and follow the contours (or loft lines) of the underside of the aircraft as closely as possible without protrusions or recesses.

Therefore, during manufacture of the aircraft, or after significant maintenance, the components are typically attached to the aircraft in the following sequence. First, the landing gear door 140 is attached to the fuselage 105 via hinges 135 and the landing gear assembly 120 is retracted and extended, more than once if necessary, in order to adjust and confirm correct alignment of landing gear door 140 with the fuselage 105 and the wing 106. Next the hinged leg fairing 160 is attached to the aircraft wing 106 via a hinge 125. Once again the landing gear assembly 120 is retracted and extended, possibly multiple times, in order to confirm correct alignment of the hinged leg fairing 160. Finally, the leg fairing 150 is attached to the leg of the landing gear assembly 120 and once again the landing gear assembly 120 is retracted and extended, in order to ensure that the leg fairing is correctly adjusted with respect to the underside of the wing 106, the landing gear (wheel bay) door 140 and the hinged leg fairing 160.

The above process is slow and complex. Furthermore, the repeated extension and retraction of the landing gear increases the risk of damage and/or injury occurring during this process, and may necessitate safety sequences that interrupt co-working in the region of the landing gear.

The disclosure herein seeks to mitigate or overcome one or more of the above-mentioned problems. Alternatively or additionally, the disclosure herein seeks to provide an improved aircraft assembly jig and an improved method of installing components at an aircraft.

### SUMMARY

According to a first aspect of the disclosure herein, an aircraft assembly jig for installing a plurality of components at a surface of an aircraft is provided. The jig comprises an elevation platform arranged for elevating the plurality of components together towards the aircraft, and a plurality of adjustable jig members coupled to the elevation platform, each one of the plurality of adjustable jig members being arranged for directly or indirectly supporting a component of the plurality of components. In this way at least one of the plurality of jig members is independently adjustable with respect to the elevation platform, such that the position of at least one of the plurality of components may be independently adjusted prior to installation at the surface of the aircraft. The components are thereby pre-positioned for installation at the surface of the aircraft.

In this way the components may be installed at the aircraft together, already pre-positioned into the correct alignment. This facilitates faster and simpler installation. A reduced requirement for repeated extension and retraction of the landing gear is also facilitated, further improving safety and speed of assembly.

Preferably, respective outer surfaces of the plurality of components are pre-positioned and supported so as to extend continuously with the surface of the aircraft following installation, with the landing gear in a retracted condition. That is, the plurality of components are arranged to be contiguous when attached to the surface of the aircraft.

The components may be door components which together close an orifice of the aircraft, such as a landing gear bay. By way of non-limiting example, the term door encompasses a landing gear wheel bay hinged door, a leg fairing hinged door, and a leg fairing fixedly attached to a leg of a landing gear assembly and rotatable with the leg about a landing gear pintle. These exemplary doors also act as fairings, and may be referred to as fairings where appropriate. The components preferably comprise landing gear door components. The components may for example comprise two, or three (or possibly more than three) landing gear doors, and optionally other components associated with the doors.

Preferably the adjusted position of at least one of the plurality of components is based on at least one measurement derived from the aircraft. Aircraft manufacturing tolerances may mean that two aircraft of the same type have different dimensions. The at least one measurement is preferably taken directly from the aircraft to which the components are to be fitted.

At least one of the plurality of jig members preferably comprises a lifting device for raising a first component of the plurality of components coupled to the at least one of the plurality of jig members independently of the other of the plurality of components. The lifting device may be hydraulically actuated, or actuated in any other convenient manner.

Preferably the lifting device comprises a plurality of lifting members. In this way the vertical position of the first component may be adjusted independently of the other components of the plurality of components by the plurality of lifting members operating together, and the first component may be rotated about a horizontal plane independently of the other components of the plurality of components by the plurality of lifting members operating differentially (for example, such that the first component undergoes rotational movement about an axis that is aligned with the horizontal plane). The lifting device may comprise three lifting members arranged in a triangular configuration, or four lifting members arranged in a rectangular configuration, for example.

At least one of the plurality of jig members preferably comprises a turntable for rotating a first component of the plurality of components coupled to the at least one of the plurality of jig members independently of the other of the plurality of components. In this way the first component may be rotated about a vertical axis, independently of the other components.

Preferably at least one of the plurality of jig members comprises an adjustable base arranged to move horizontally with respect to the elevation platform. In this way a first component of the plurality of components coupled to the at least one of the plurality of jig members may be adjusted horizontally independently of the other of the plurality of components. The adjustable base may comprise two mutually orthogonal tracks, or a similar arrangement which allows the first component to be adjusted horizontally in two mutually perpendicular axes (i.e. x- and y-axes).

The plurality of jig members preferably comprises three jig members. At least two, or preferably all of the jig members each have a lifting device, a turntable and/or an adjustable base as described above.

Preferably the assembly jig further comprises a temporary upper jig member arranged for providing position guidance via at least one attachment point corresponding to the position of at least one attachment point at the aircraft. At least one of the plurality of components comprises at least one adjustable coupling arranged for attaching to the at least one attachment point at the aircraft. In this way the temporary upper jig member allows the at least one adjustable coupling to be adjusted in length prior to installing the plurality of components at the aircraft. The attachment point of the upper jig member may be adjustable so as to match the location and orientation of the at least one attachment point at the aircraft.

According to a second aspect of the disclosure herein there is also provided a method of installing a plurality of doors to an aircraft. The method includes attaching a first door to a first adjustable member of the jig; adjusting the position of the first door via the first adjustable member; attaching a second door to a second adjustable member of the jig; adjusting the position of the second door via the second adjustable member; elevating the first and second adjustable members towards the aircraft together; and installing the first and second doors at the first and second locations respectively. The various elements of the method may be performed in any appropriate order. In this way the first and second doors are correctly positioned for installation, that is, positioned as required to be installed in alignment with each other and with the aircraft, at the first and second locations respectively. This allows the first and second doors to be installed at the aircraft together, which speeds up and simplifies the installation. Furthermore, repeated extension and retraction of the landing gear is minimised, improving safety.

Preferably prior to fitting the plurality of doors to the aircraft, the method includes determining at least one dimensional parameter of the aircraft for use in adjusting the position of the first door so that the first door is pre-configured to fit an orifice of the aircraft.

The step of adjusting the position of the first door via the first adjustable member preferably includes adjusting the height of the first door with respect to the second door.

Preferably the step of adjusting the position of the first door via the first adjustable member includes adjusting the horizontal position of the first door with respect to the second closure component.

The step of adjusting the position of the first door via the first adjustable member preferably includes rotating the first door about a horizontal plane with respect to the second door.

The method preferably further comprises the steps of: attaching a temporary upper jig member to at least the first door and adjusting at least one adjustable coupling of the first door in dependence on the position of the temporary upper jig member. The at least one adjustable coupling is arranged for attaching to the aircraft. Prior to elevating the first and second adjustable members towards the aircraft together, the temporary upper jig member is removed. In this way the temporary upper jig member provides for the at least one adjustable coupling to be adjusted in length prior to installing the plurality of components at the aircraft.

According to a further aspect of the disclosure herein there is also provided an assembly jig adapted to support a plurality of components in pre-determined positions for assembly of aircraft components to an aircraft, the jig comprising:
a plurality of jig members, at least one of the jig members being adjustable relative to a jig datum independently of the other jig members such that the relative positions and/or orientations of at least one of the plurality of components may be adjusted to move the components into relative alignment with one another and with a portion of the aircraft to which they will be assembled; and
a lifting arrangement adapted to lift the jig members with the components together, for example on a common base or under common control, into an installation position at the portion of the aircraft, in which the components are in position to connect to connection portions of the aircraft with the components in alignment with outer surface portions of the other supported components and with an outer surface of the aircraft.

The components preferably comprise at least one landing gear fairing and/or door. In some examples, the components further comprise actuators and/or other connectors connected internally of the or each landing gear fairing and/or door.

According to a still further aspect of the disclosure herein there is also provided an assembly jig adapted to support a plurality of components in pre-determined positions for the assembly of aircraft components to an aircraft, the jig comprising:
a plurality of jig members, at least one of the jig members being independently adjustable relative to the jig, such that the relative positions and/or orientations of at least one of the plurality of components may be adjusted to support the components in relative alignment with one another and with a portion of the aircraft, for assembly thereto; and
a lifting arrangement adapted to lift the jig members, to move the aligned components into an installation position adjacent the portion of the aircraft, such the that the components are positioned readily to connect to connection portions of the aircraft while retaining a predetermined alignment with outer surface portions of the other supported components and with an outer surface of the aircraft.

According to a further aspect of the disclosure herein there is provided a method of installing a plurality of landing gear doors to an aircraft, the method comprising:
using a plurality of adjustable jig members to adjustably position and support on the jig a plurality of landing gear doors in a predetermined orientation with edge portions thereof sealingly engaged with one another, and with their outer surfaces aligned so as to provide a substantially continuous outer surface across the doors;
lifting the jig members in the predetermined orientation into an installation position of the components at the aircraft; and
installing the doors to the aircraft in the predetermined orientation.

The method preferably further comprises adjustably positioning and supporting the doors on the platform (e.g. of the jig) in a predetermined orientation with outer edge portions thereof aligned for sealing engagement with corresponding inner edge portions of a landing gear bay, and with their outer surfaces aligned with the outer surfaces of the aircraft around the landing gear bay, so as to provide a substantially continuous outer surface between the doors and the aircraft.

At least one connector strut, for example an actuator strut, may be connected to at least one of the doors prior to lifting (or elevating), the method further comprising adjusting the or each connector strut for connection to the aircraft.

The method may comprise performing final functional tests in parallel with installation of the landing gear doors.

According to a further aspect of the disclosure herein there is provided an aircraft made according to the method of any of paragraphs [0020] to [0025] and [0029] to [0032] above, or using the jig of any of paragraphs [0009] to [0019] and [0026] to [0028] above.

The aircraft is preferably a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and more preferably more than 50 passengers. The aircraft may be a commercial aircraft, for example a commercial passenger aircraft, for example a single aisle or twin aisle aircraft.

It will of course be appreciated that features described in relation to one aspect of the disclosure herein may be incorporated into other aspects of the disclosure herein. For example, the method of the disclosure herein may incorporate any of the features described with reference to the apparatus of the disclosure herein and vice versa.

### BRIEF DESCRIPTION OF THE DRAWINGS

Embodiments of the disclosure herein will now be described by way of example only with reference to the accompanying schematic drawings of which:

FIGS. 1a and 1b show a prior art arrangement of an aircraft with retractable landing gear;

FIG. 2 shows an aircraft assembly jig according to a first embodiment of the disclosure herein on which doors are mounted for fitting to an aircraft;

FIG. 3 shows the aircraft assembly jig of FIG. 2, further including an upper jig member;

FIG. 4 shows an independently operable lifting platform 300 of the assembly jig of FIGS. 2 and 3; and

FIG. 5 is a flow diagram illustrating a method of installing a plurality of components on an aircraft, in accordance with an embodiment of the disclosure herein.

### DETAILED DESCRIPTION

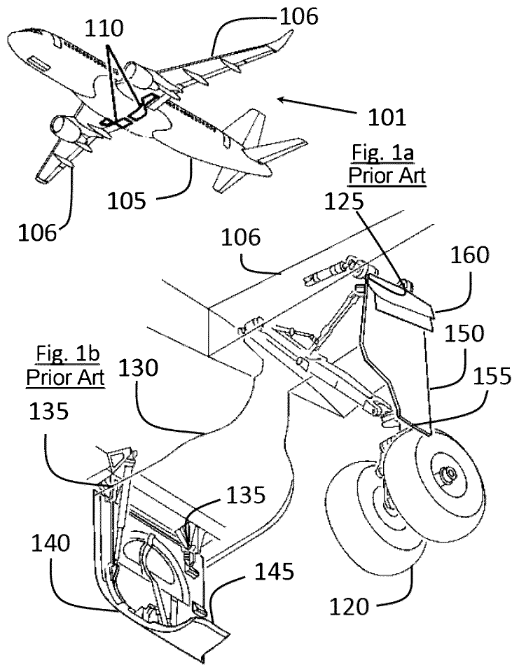

FIG. 1a shows an aircraft 101 comprising a fuselage 105 and a pair of wings 106. The aircraft 101 also includes sets of landing gear door components 110, which provide a contiguous covering at the underside of the fuselage 105 and wings 106, to cover apertures for landing gear bays (not shown) when in a retracted configuration.

Referring now also to FIG. 1b, a portion of the aircraft 101 is depicted with the left (port) side of the landing gear door components 110 of FIG. 1a shown in greater detail, in an extended (deployed) position. The door components comprise a landing gear door 140, a landing gear leg fairing door 150, and hinged leg door 160. A main landing gear assembly 120 of the aircraft 101 is pivotally coupled to the wing 106 via pintles, such that when retracted the main landing gear assembly 120 is housed within a landing gear bay 130.

As mentioned above the landing gear door 140, landing gear door fairing 150, and hinged leg fairing 160 fit together when the main landing gear assembly 120 is retracted to form a contiguous covering of the landing gear bay 130. The landing gear door 140 is pivotally coupled via hinged mounts 135 to the fuselage 105, such that when the main landing gear assembly 120 is retracted, the landing gear door 140 partially closes the landing gear bay 130.

The landing gear door fairing 150 is fixedly attached to a main leg of the main landing gear assembly 120, such that when the main landing gear assembly 120 is retracted, the landing gear door fairing 150 also partially closes the landing gear bay 130. Furthermore, when the main landing gear assembly 120 is retracted, a lower edge 155 of the landing gear door fairing 150 is arranged to abut an edge 145 of the landing gear door 140.

Similarly a hinged leg fairing, or door, 160 is attached to the wing 106 via a hinged joint 125 such that when the main landing gear assembly 120 is retracted, the hinged leg fairing 160 rotates about the hinged joint 125 to close the hinged leg fairing 160. When closed, the hinged leg fairing 160 abuts an edge of the landing gear door fairing 150 (opposite the lower edge 155). In this way the arrangement of the landing gear door 140, landing gear door fairing 150, and hinged leg fairing 160 together close the landing gear bay 130 to the exterior when the main landing gear assembly 120 is retracted.

It will be appreciated that during assembly of the aircraft, or during subsequent maintenance requiring removal and replacement of the landing gear assembly 120, each of the landing gear door 140, door fairing 150, and hinged leg fairing 160 must be carefully aligned and installed on the aircraft 101, in order that when the landing gear assembly 120 is in a retracted state, their relative positions follow the contours of the underside of the aircraft 101, and when the landing gear assembly 120 is being extended or retracted, they do not interfere with each other.

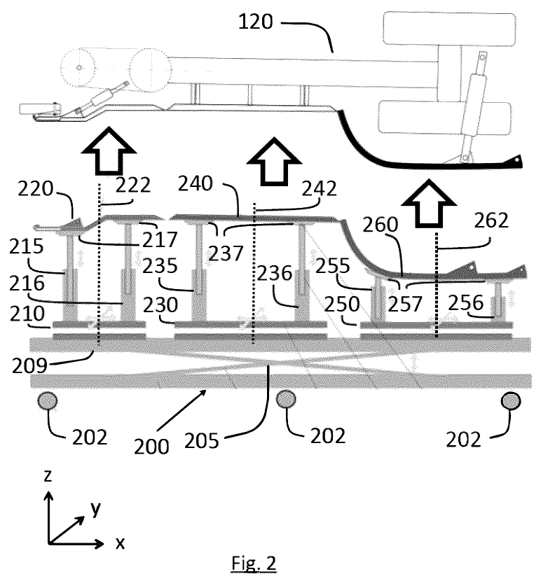

Referring to FIG. 2, an assembly jig 200 is shown, on which doors in the form of a hinged leg fairing 220, a door fairing 240, and a landing gear door 260 are mounted to be fitted to an aircraft. These correspond to the hinged leg fairing 160, the door fairing 150, and the landing gear door 140 shown in FIG. 1b.

The assembly jig 200 has wheels 202 which facilitate movement across a floor of a facility in which an aircraft (not shown in FIG. 2) is being assembled. The assembly jig 200 also has a lifting device 205, and first, second and third independent lifting platforms 210, 230 and 250 respectively, each mounted on the lifting device 205. The lifting device 205 provides a common base 209, together to raise and lower (i.e. to move vertically along a direction of the z-axis) the first, second and third independently operable lifting platforms 210, 230 and 250.

The jig 200 also has a datum (not shown) which provides a position reference. Each of the first, second and third independent lifting platforms 210, 230 and 250 respectively may be positioned with reference to the jig datum.

Each of the independent lifting platforms 210, 230 and 250 respectively has a set of four coupling pads, only two of which in each case are seen in the FIG. 2 (pads 217, 237 and 257 respectively). The sets of coupling pads are each arranged to support an aircraft component to be further described below. Each pad within the sets of coupling pads 217, 237 and 257 respectively may include securing devices for securing the aircraft component to the pad.

The first independent lifting platform 210 has a set of jacks 215 and 216, on which the hinged leg fairing 220 is mounted via the pair of coupling pads 217. It will be appreciated that two further jacks are behind the jacks 215 and 216, and are omitted for FIG. 2. When the set of jacks 215 and 216 operate together, this allows the position of the leg fairing 220 to be adjusted vertically (movement in the z-axis), separately from the action of the lifting device 205 when it lifts the common base 209. Furthermore, differential action of the set of jacks 215, 216, allows the leg fairing 220 to be rotated in a manner to be more fully described below. The typical range of movement is +/−10 degrees of rotation. The first independent lifting platform 210 is also arranged via a turntable arrangement (not shown) to rotate about the vertical (z-) axis with respect to the lifting device 205 as shown by the dashed line 222. The typical range of movement is +/−10 degrees of rotation. The first lifting platform 210 is further arranged to move horizontally with respect to the lifting device 205 by virtue of a tracks or similar devices, providing a limited range of movement along a longitudinal axis (x) and a transverse axis (y), typically of 0.5 m.

Similarly, the second independent lifting platform 230 has a set of jacks 235 and 236, on which the door fairing 240 is mounted via the pair of coupling pads 237. It will be appreciated that two further jacks are behind the jacks 235 and 236, and are omitted. This allows, in a similar manner to that described above with respect to the first independent lifting platform 210, adjustment of the position of the door fairing 240 vertically (z-axis) independent of the lifting device 205, and rotationally in a manner to be more fully described below. The second independent lifting platform 230 is also arranged via a turntable arrangement (not shown) to rotate about the vertical (z-) axis with respect to the lifting device 205 as shown by the dashed line 242. The typical range of movement is +/−10 degrees of rotation. The second lifting platform 230 is also arranged to move horizontally with respect to the lifting device 205 by virtue of a tracks or similar devices, providing a limited range of movement along a longitudinal axis (x) and a transverse axis (y), typically of 0.5 m.

In a similar manner, the third independent lifting platform 250 has a set of jacks 255 and 256, on which the landing gear door 260 is mounted via the pair of coupling pads 257. It will be appreciated that two further jacks are behind the jacks 255 and 256, and are omitted for clarity. This allows, in a similar manner to that described above with respect to the first and second independent lifting platforms 210 and 230 respectively, adjustment of the position of the landing gear door 260 vertically (z-axis) independent of the lifting device 205, and rotationally in a manner to be more fully described below. The third independent lifting platform 250 is also arranged via a turntable arrangement (not shown) to rotate about the vertical (z-) axis with respect to the lifting device 205 as shown by the dashed line 262. The typical range of movement is +/−10 degrees of rotation. Finally, the third lifting platform 250 is also arranged to move horizontally with respect to the lifting device 205 by virtue of a tracks or similar devices, providing a limited range of movement along a longitudinal axis (x) and a transverse axis (y), typically of 0.5 m.

The jacks, turntables and tracks described above may all be controlled manually, or with control apparatus linked to a computer system or other automated means. Control cables, levers and other control apparatus are well-known in the field of manufacturing and are omitted from the figures for the sake of clarity.

It will be appreciated that the assembly jig 200, by virtue of the lifting device 205, is able to elevate the hinged leg fairing 220, the door fairing 240, and the landing gear door 260 towards an aircraft to which these three components are to be fitted. Furthermore, the first, second and third independently operable lifting platforms 210, 230 and 250 respectively, and their associated apparatus, allow each of the hinged leg fairing 220, the door fairing 240, and the landing gear door 260 respectively to be independently adjusted in the x-, y- and z-axes, and to be independently rotated about the x-y- and z-axes, in order for their correct respective alignment with each other and with the contours of the aircraft 101 to which they are to be fitted.

This ensures that when being installed at the aircraft 101, each of the hinged leg fairing 220, the door fairing 240, and the landing gear door 260 respectively are correctly positioned in relation to each other and in relation to other panels/components of the aircraft 101.

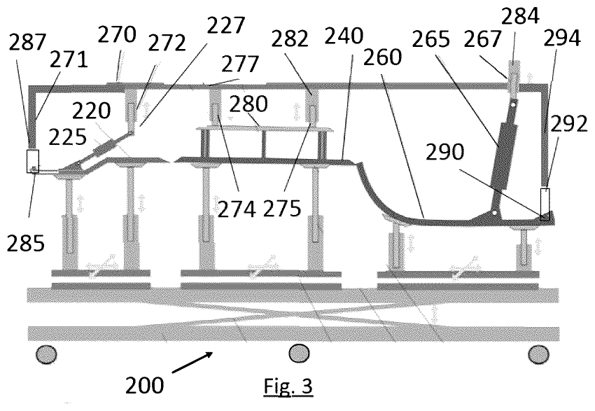

Referring now also to FIG. 3, the arrangement depicted in FIG. 2 is shown again, this time with each of the hinged leg fairing 220, the door fairing 240, and the landing gear door 260 respectively coupled to an upper jig member 270 via connecting rods and members to be further described below.

The hinged leg fairing 220 has a hinge coupling 285 which is arranged, when the hinged leg fairing 220 is attached to the aircraft 101, for coupling the hinged leg fairing 220 to a first attachment point of the aircraft 101. A first adjustable coupling 287 of the upper jig member 270 is attached to a first connection point 271 of the upper jig member 270, and is arranged to replicate the position of the first attachment point of the aircraft 101. Therefore the hinge coupling 285 will be correctly positioned with respect to the aircraft 101 when it is coupled to the first adjustable coupling 287.

The hinged leg fairing 220 also includes an actuator 225, one end of which is arranged to be coupled to a second attachment point at the landing gear assembly 120. A second adjustable coupling 227 is attached to a second connection point 272 of the upper jig member 270, and is adjustable in order to replicate the position of the second attachment point at the landing gear assembly 120. In this way the actuator 225 will be correctly positioned with respect to the landing gear assembly 120 when it is coupled to the second adjustable coupling 227.

A jig fairing member 280 has third and fourth adjustable couplings 274 and 275 respectively, which are coupled to third and fourth connection points 277 and 282 respectively of the upper jig member 270 and which are adjustable in order to hold the jig fairing member 280 in a position which replicates the position of the main leg of the landing gear assembly 120. Therefore, the door fairing 240 will be correctly positioned with respect to the main leg of the landing gear assembly 120 when it is coupled to the jig fairing member 280.

The landing gear door 260 includes an actuator 265, one end of which is arranged to be coupled to a third attachment point of the aircraft 101. A fifth adjustable coupling 267 is attached to a fifth connecting point 284 of the upper jig member 270, and is adjustable in order to replicate the position of the third attachment point of the aircraft 101. In this way the actuator 265 will be correctly positioned with respect to the aircraft 101 when it is coupled to the fifth adjustable coupling 267.

The landing gear door 260 also has a hinge coupling 290 which is arranged, when the landing gear door 260 is attached to the aircraft 101, for coupling the landing gear door 260 to a fourth attachment point of the aircraft 101. A sixth adjustable coupling 292 is attached to a sixth connecting point 294 of the upper jig member 270, and is adjustable in order to replicate the position of the fourth attachment point of the aircraft 101. In this way hinge coupling 290 will be correctly positioned with respect to the aircraft 101 when it is coupled to the sixth adjustable coupling 267.

The first, second, third and fourth adjustable couplings 287, 227, 274, 275, 267 and 292 respectively of the upper jig member 270 are each independently adjustable to match the positions of their respective connection points on the aircraft 101. Therefore the upper jig member 270 thus provides further positional information, whereby the positions of the hinged leg fairing 220, the door fairing 240, the landing gear door 260, and the actuators 225 and 265 may each be independently adjusted prior to their installation at the aircraft.

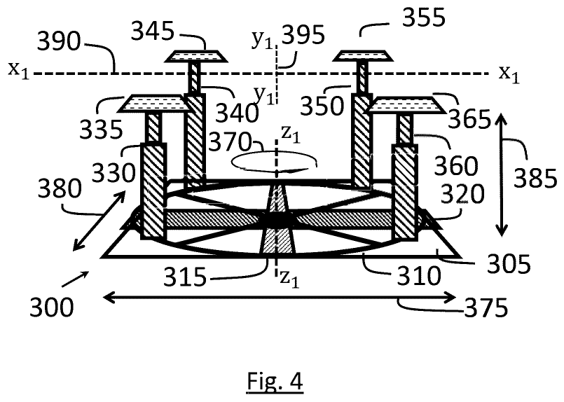

Referring now also to FIG. 4, a more detailed view of an independently operable lifting platform 300 forming part of the assembly jig 200 of FIGS. 2 and 3 is shown. A base 305 of the independent lifting platform 300 is provided for attachment to the common base 209 of the assembly jig 200. A turntable 310 is mounted on the base 305, in order to provide rotational movement about the vertical (z-) axis, as shown by arrow 370. The turntable 310 is further arranged to be moved along the directions of the x- and y-axes (shown by arrows 375 and 380 respectively) via tracks 315 and 320 disposed in the base 305.

First, second, third and fourth jacks 330, 340, 350 and 360 respectively are mounted on the turntable 310. Each of the first, second, third and fourth jacks 330, 340, 350 and 360 respectively has a pad (pads 335, 345, 355 and 365 respectively) for supporting a component such as the hinged leg fairing 220, the door fairing 240, and the landing gear door 260 respectively.

It will be appreciated that action in unison of the first, second, third and fourth jacks 330, 340, 350, 360 is able to move an attached component along a direction of a vertical axis, as indicated by arrow 385. In addition, if the second and third jacks 340 and 350 respectively are operated together, but differentially with respect to the first and fourth jacks 330 and 360 respectively, rotation of an attached component is possible about the x-axis as shown by the arrow 390. The typical range of movement is +/−10 degrees of rotation.

Similarly, if the first and second jacks 330 and 340 respectively are operated together, but differentially with respect to the third and fourth jacks 350 and 360 respectively, rotation of an attached component is possible about the y-axis, as shown by arrow 395. Once again the typical range of movement is +/−10 degrees of rotation.

In this way the lifting platform 300 allows an attached component such as the hinged leg fairing 220, the door fairing 240, and the landing gear door 260 respectively to be independently adjusted in the x-, y- and z-axes, and to be independently rotated about the x-, y- and z-axes, in order for correct alignment and orientation with respect to other components and with the contours of the aircraft 101 to which it is to be fitted.

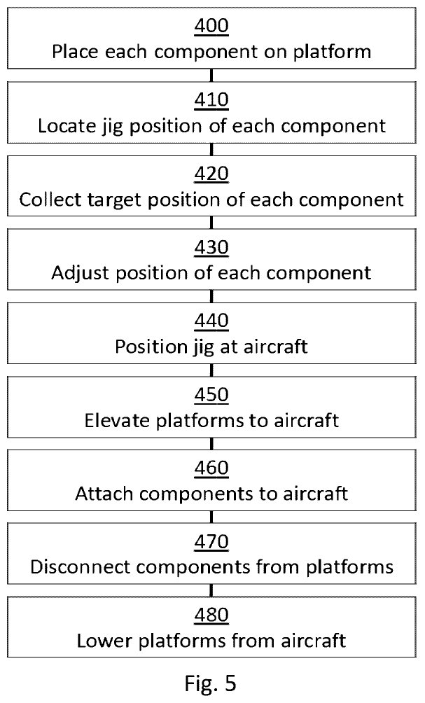

In operation, and referring now also to FIG. 5, a method of fitting the hinged leg fairing 220, the door fairing 240, and the landing gear door 260 respectively to the aircraft 101 will be described.

Firstly, each of the hinged leg fairing 220, the door fairing 240, and the landing gear door 260 respectively are placed on to the adjustable jig 200, as depicted in box 400.

Then each of the hinged leg fairing 220, the door fairing 240, and the landing gear door 260 respectively are located (i.e. each of their positions determined) against a datum on the jig 200, as depicted by box 410.

The target (i.e. required) position of each of the hinged leg fairing 220, the door fairing 240, and the landing gear door 260 respectively are then determined, with respect to the datum of the jig 200, as depicted at box 420. This may be done by direct measurement at the aircraft 101, or by some other means such as derivation from batch information concerning other aircraft or landing gear assemblies in production.

Then the position of each of the hinged leg fairing 220, the door fairing 240, and the landing gear door 260 respectively is adjusted, based on the respective target position identified in box 430 above, by adjusting the heights of each of the jacks 215, 216, 235, 236, 255 and 256 respectively, and by adjusting the horizontal positions of each of the independent lifting platforms 210, 230 and 250 respectively, via the tracks and turntables described above.

It will be appreciated that suitable controls (not shown) may be utilized, such as computer controlled position guidance using lasers, cameras or other distance measuring equipment, in order to provide an operator of the adjustable jig 200 with an efficient means to adjust the positions of each of the hinged leg fairing 220, the door fairing 240, and the landing gear door 260 respectively.

The jig 200 is then positioned under the aircraft 101, with the datum of the jig 200 correctly aligned with a corresponding datum at the aircraft 101, as depicted by box 440. The lifting device 205 is then actuated to lift the first, second and third lifting platforms 210, 230 and 250 respectively in unison, in order for each of them to reach their final positions, as depicted in box 450. Each of the hinged leg fairing 220, the door fairing 240, and the landing gear door 260 respectively are then attached to the aircraft 101, via the first, second third and fourth connecting rods 280, 285, 290 and 295, as depicted in box 460. The hinged leg fairing 220, the door fairing 240, and the landing gear door 260 respectively are then each disconnected from the first, second and third lifting platforms 210, 230 and 250 respectively, as depicted at box 470. Finally, the lifting device 205 is used to lower the first, second and third lifting platforms 210, 230 and 250, as depicted at box 480, at which point the jig 200 may be removed from the vicinity of the aircraft 101.

In the alternative arrangement as shown in FIG. 3, the above method is augmented by the use of the upper jig member 270 in the following way. At the step depicted at box 430, the first, second, third and fourth adjustable couplings 287, 227, 274, 275, 267 and 292 respectively of the upper jig member 270 are each independently adjusted to match the positions of their respective connection points on the aircraft 101. This provides further position information in order to adjust the position of each of the hinged leg fairing 220, the door fairing 240, and the landing gear door 260. Therefore the hinged leg fairing 220, the door fairing 240, and the landing gear door 260 respectively are pre-rigged to the positions required for installation at the aircraft 101.

While the disclosure herein has been described and illustrated with reference to particular embodiments, it will be appreciated by those of ordinary skill in the art that the disclosure herein lends itself to many different variations not specifically illustrated herein. By way of example only, certain possible variations will now be described.

The quad arrangement of two forward and two rear lifting jacks as described and shown with respect to FIG. 4 could be replaced by a tripod arrangement of three lifting jacks. Differential action of such an arrangement would still would provide rotational adjustment about the x- and y-axes. Furthermore, the arrangement of the upper jig member 270 may differ from that described and shown. For example, the upper jig member 270 may include more or fewer adjustable couplings, or further elements which replicate further components of the aircraft 101, such as wing lower covers.

Where in the foregoing description, integers or elements are mentioned which have known, obvious or foreseeable equivalents, then such equivalents are herein incorporated as if individually set forth. Reference should be made to the claims for determining the true scope of the disclosure herein, which should be construed so as to encompass any such equivalents. It will also be appreciated by the reader that integers or features of the disclosure herein that are described as preferable, advantageous, convenient or the like are optional and do not limit the scope of the independent claims. Moreover, it is to be understood that such optional integers or features, while of possible benefit in some embodiments of the disclosure herein, may not be desirable, and may therefore be absent, in other embodiments. It will be appreciated that in performing the various methods described herein, activities or steps of the methods may be executed in any appropriate order.

It should be understood that modifications, substitutions, and alternatives of the present invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft assembly jig for installing a plurality of components at a surface of an aircraft, the jig comprising:
an elevation platform to elevate the plurality of components together towards the aircraft; and
a plurality of adjustable jig members coupled to the elevation platform, each of the plurality of adjustable jig members being configured to support a component of the plurality of components;
wherein at least one of the plurality of jig members is independently adjustable with respect to the elevation platform, such that a position of at least one of the plurality of components can be independently adjusted and the components pre-positioned for installation at the surface of the aircraft.

2. The aircraft assembly jig of claim 1, wherein respective outer surfaces of the plurality of components are pre-positioned and supported to extend continuously with the surface of the aircraft following installation, with the landing gear in a retracted condition.

3. The aircraft assembly jig of claim 1, wherein the plurality of components comprise landing gear door components.

4. The aircraft assembly jig of claim 1, wherein an adjusted position of at least one of the plurality of components is based on at least one measurement derived from the aircraft.

5. The aircraft assembly jig of claim 1, wherein at least one of the plurality of jig members comprises a lifting device for elevating a first component of the plurality of components coupled to the at least one of the plurality of jig members independently of another of the plurality of components.

6. The aircraft assembly jig of claim 5, wherein the lifting device comprises a plurality of lifting members, and wherein a vertical position of the first component is adjustable independently of other components of the plurality of components by the plurality of members operating together, and the first component is rotatable about a horizontal plane independently of the other components of the plurality of components by the plurality of lifting members operating differentially.

7. The aircraft assembly jig of claim 1, comprising at least one turntable for rotating a first component of the plurality of components coupled to the at least one of the plurality of jig members independently of another of the plurality of components.

8. The aircraft assembly jig of claim 1, wherein at least one of the plurality of jig members comprises an adjustable base configured to move horizontally with respect to the elevation platform,
wherein a first component of the plurality of components coupled to the at least one of the plurality of jig members is adjustable horizontally independently of another of the plurality of components.

9. The aircraft assembly jig of claim 1, wherein the plurality of jig members comprise three jig members.

10. The aircraft assembly jig of claim 1, further comprising an upper jig member configured to provide position guidance via at least one jig attachment point corresponding to a position of at least one attachment point at the aircraft,
at least one of the plurality of components comprises at least one adjustable coupling configured for attaching to the at least one attachment point at the aircraft, and
wherein the upper jig member is configured to enable the at least one adjustable coupling to be pre-adjusted to a required length for installing the plurality of components at the aircraft.

11. A method of installing a plurality of doors to an aircraft, the method comprising:
attaching a first door to a first adjustable member of a jig;
adjusting a position of the first door via the first adjustable member;
attaching a second door to a second adjustable member of the jig;
adjusting a position of the second door via the second adjustable member;
elevating the first and second adjustable members towards the aircraft together; and
installing the first and second doors at first and second locations respectively,
wherein the first and second doors are positioned as required to be installed in alignment with each other and with the aircraft at the first and second locations respectively.

12. The method of claim 11, further comprising, prior to fitting the plurality of doors to the aircraft, determining at least one dimensional parameter of the aircraft for use in adjusting the position of the first door so that the first door is pre-positioned to fit an orifice of the aircraft.

13. The method of claim 11, wherein adjusting the position of the first door via the first adjustable member includes adjusting a height of the first door with respect to the second door.

14. The method of claim 11, wherein adjusting the position of the first door via the first adjustable member includes horizontally adjusting a position of the first door with respect to the second door.

15. The method of claim 11, wherein adjusting the position of the first door via the first adjustable member includes rotating the first door with respect to the second door.

16. The method of claim 11, further comprising:
attaching an upper jig member to at least the first door;
adjusting at least one adjustable coupling of the first door in dependence on a configuration of the upper jig member, the at least one adjustable coupling being configured for attaching to the aircraft; and
prior to elevating the first and second adjustable members towards the aircraft together, removing the upper jig member;
whereby the upper jig member allows for the at least one adjustable coupling to be adjusted in length to permit installation of the plurality of components in required aligned positions at the aircraft.

17. The method of claim 11, further comprising adjustably positioning and supporting the doors on a platform in a predetermined orientation with outer edge portions thereof aligned for sealing engagement with corresponding inner edge portions of a landing gear bay aperture, and with their outer surfaces aligned with outer surfaces of the aircraft that define the landing gear bay aperture, to provide a substantially continuous outer surface between the doors and the aircraft.

18. The method of claim 11, wherein at least one connector strut, or an actuator strut, is connected to at least one of the doors prior to lifting, the method further comprising adjusting the or each connector strut for connection to the aircraft.

19. The method of claim 11, comprising performing final functional tests in parallel with installation of the doors.

20. An aircraft made using the jig of claim 1.

21. An assembly jig to support a plurality of components in pre-determined positions for assembly of aircraft components to an aircraft, the jig comprising:
a plurality of jig members configured to be lifted together in unison, at least one of the jig members being adjustable relative to a jig datum independently of other jig members, such that the relative positions and or orientations of at least one of the plurality of components is or are adjustable to move the components into relative alignment with one another and with a portion of the aircraft to which they will be assembled; and
a lifting arrangement configured to lift the jig members with the components supported in the relative alignment to an installation position at the portion of the aircraft, in which the components are in position to connect to connection portions of the aircraft with the components in alignment with outer surface portions of the other supported components and with an outer surface of the aircraft.

22. The assembly jig of claim 21, wherein the components comprise at least one landing gear fairing and or door.

23. The assembly jig of claim 21, wherein the components further comprise actuators and or other connectors connected internally of the or each landing gear fairing and or door.
